(19) United States
(12) Patent Application Publication
(10) Pub. No.: US 2008/0053718 A1
(43) Pub. Date: Mar. 6, 2008

(54) System & method to provide a variable traction to a drive wheel for a vehicle

(76) Inventor: Armen Shagbazyan, Glendale, CA (US)

Correspondence Address: WILSON DANIEL SWAYZE, JR., 3804 CLEARWATER CT., PLANO, TX, 75025, US

(21) Appl. No.: 11/516,162

(22) Filed: Sep. 6, 2006

(51) Int. Cl. B62D 61/10; B62D 17/00

(52) U.S. Cl. 180/24.02; 280/86.75

(57) ABSTRACT

A system for providing a variable traction to a drive wheel of a vehicle includes a front axle for supporting the weight of the vehicle, a rear axle for supporting the weight of the vehicle, a middle axle for providing said variable traction to the drive wheel of the vehicle.

### FIELD OF THE INVENTION

The present invention relates to vehicles such as cars, trucks and trailers and more particularly to an apparatus for providing variable traction to a set of wheels of the vehicle.

### BACKGROUND OF THE INVENTION

Vehicles that rely on constant traction have inherited inefficiencies because in some cases too much traction is being applied and in other cases to little traction is being applied. This results in engine inefficiencies which increase fuel usage and engine wear.

### SUMMARY OF THE INVENTION

The present invention provides an apparatus and method to provide variable traction to a wheel of the vehicle and consequently improves the fuel efficiency and engine life of a vehicle, regardless if the vehicle is an automobile, a truck or a truck and trailer. The present invention provides a system for automatically adjusting the traction so that the near optimal traction is applied to the wheels to increase engine output and engine efficiency.

The present invention provides for a cost effective fuel energy saving apparatus which helps in reducing environmental pollution, increasing engine life of a vehicle, increasing economy growth, lowering the cost of transportation and a lower maintenance cost of the vehicle. The present invention provides a system and method for improving the fuel efficiency and increasing the engine life of the vehicle.

A system is disclosed for providing a variable traction to a drive wheel of a vehicle having a front axle for supporting the weight of the vehicle, a rear axle for supporting the weight of the vehicle and a middle axle for providing the variable traction to the drive wheel of the vehicle.

The middle axle is connected to a middle axle shaft which is connected to a transmission for receiving power from the engine.

A portion of the weight is distributed to the front axle and another portion of the weight is distributed to the rear axle.

The traction is adjusted by a hydraulic cylinder by which the traction is increased by extending the hydraulic cylinder and by inflating the hydraulic cylinder and the traction is decreased by retracting the hydraulic cylinder and by deflating the hydraulic cylinder. The hydraulic cylinder is attached to a hydraulic pump which is located under the hood of the vehicle by a hydraulic hose.

The hydraulic cylinder is activated by an activation switch positioned within the cab of the vehicle. The activation switch is connected to the hydraulic pump by electrical wire.

The rotation of the front axle, middle axle and rear axle is measured by sensors which are connected to a controller to adjust the traction.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a left side view of a truck and trailer with a lifted middle axle;

FIG. 2 illustrates the left side view of the truck and trailer with a lowered middle axle;

FIG. 3 illustrates the right side of the truck without tires.

### DETAILED DESCRIPTION OF THE INVENTION

The exemplary embodiments described herein detail for illustrative purposes are subject to many variations, structure and design. It should be emphasized, however that the present invention/description is not being limited to a particular system but as providing variable traction for improving the fuel efficiency and engine life of a vehicle/truck and trailer.

Rather, the principles of the present invention can be used with a variety of truck and trailer assembly configurations and structural arrangements. It is understood is that various omissions, substitutions of equivalents are contemplated as circumstances may suggest or render expedient, but is intended to cover the application or implementation without departing from the spirit or scope of the claims of the present invention.

The present invention provides an apparatus and method to improve the fuel efficiency and engine life of a vehicle, and more particularly, the present invention provides a system and method for improving the fuel efficiency and engine life of a vehicle such as an automobile, a truck and a truck and trailer. The present invention provides a system for automatically adjusting the traction applied to the automobile's wheels, the truck's wheels or the truck and trailer wheels. Although the present invention illustrates the teachings of the present invention in terms of a third set of wheels, the principles and teachings of the present invention are equally applicable to an automobile, a truck, the truck and trailer with fewer wheels or additional wheels.

The present invention provides for cost effective fuel energy saving apparatus which helps in reducing environmental pollution, in increasing engine life of a vehicle, in economic growth, in lowering the cost of transportation and lower maintenance cost of vehicle. The present invention provides a system and method for providing near optimal traction to a set of wheels of the vehicle, improving the fuel efficiency and increasing the engine life of the vehicle.

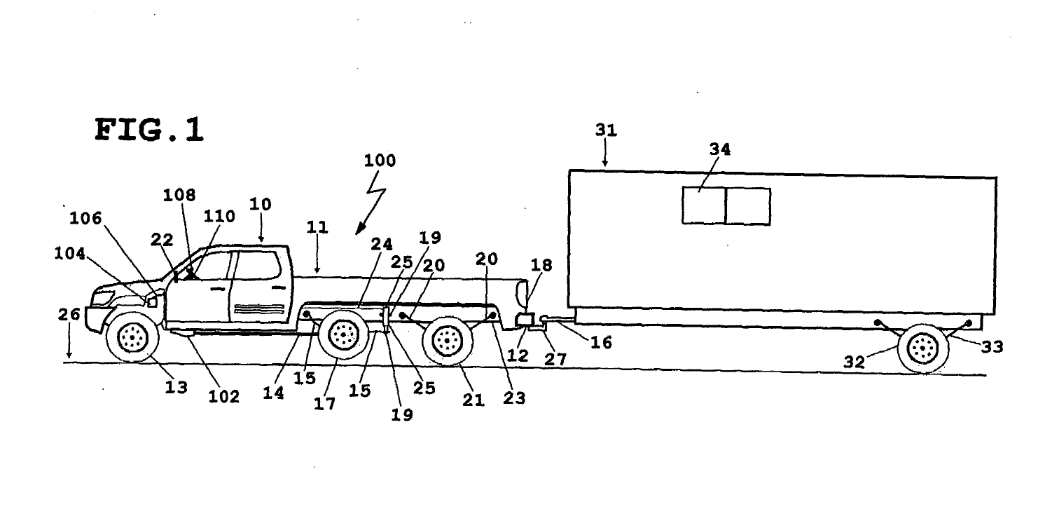

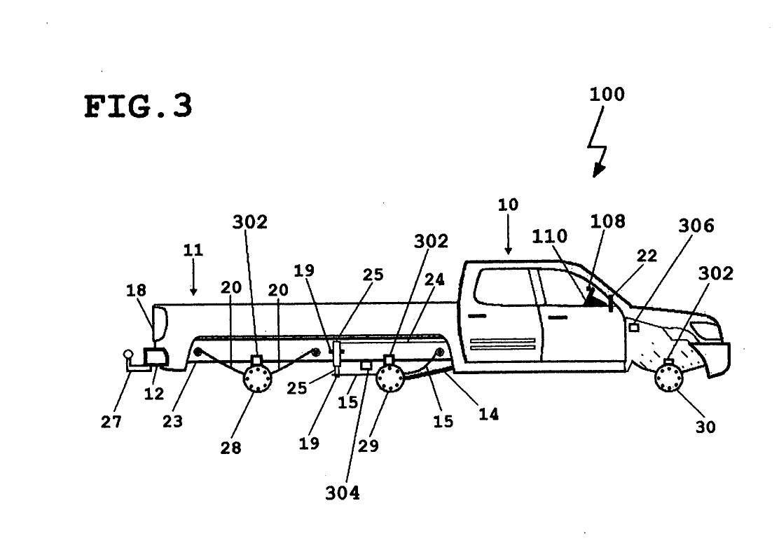

FIG. 1 illustrate an exemplary embodiment of the present invention where the system 100 for automatically adjusting the traction to the axles of the truck and trailer assembly has been explained in detail. In an embodiment, as shown in FIG. 1, the system 100 as shown includes a truck cab 10 for the occupants of the vehicle, a truck bed 11 to provide a storage area for the users of the vehicle. The system 100 also includes a bumper 12 shown as being mounted on the rear of the vehicle and a vehicle tow hitch 27 which optionally is used to connect to the trailer 31. FIG. 1 additionally shows a front tire 13 which may be used to carry a portion of the weight of the vehicle. The system 100 additionally includes a middle axle shaft 14 to transmit power from the engine of the vehicle to the middle axle tire 17 by a transmission 102. FIG. 1 additionally shows a taillight 18 positioned above the bumper 12 and the trailer tow hitch 16. Attached to the middle axle shaft 14 is a middle axle suspension 15 which is connected to the middle axle tire 17 and which lowers and raises the middle axle tire 17 by virtue of the hydraulic cylinder 25. The variable traction is achieved in part by raising and lowering the middle axle tire 17. A bolt 19 or other suitable fastening device could be used to connect the middle axle suspension 15 to the hydraulic cylinder 25 which may be an air cylinder. By extending through inflation the hydraulic cylinder 25, the middle axle suspension 15 is moved closer to the road surface 26 and the middle axle tire 17 is moved closer to the road surface 26. Likewise by retracting through deflation of the hydraulic cylinder 25, the middle axle suspension 15 and the middle axle tire 17 are moved closer to the road surface 26. When the middle axle tire 17 touches the road surface 26, the traction between the middle axle tire 17 and the road surface 26 begins to increase. If the hydraulic cylinder 25 continues to extend towards the road surface 26, then the traction of the middle axle tire 17 will correspondingly increase, and if the hydraulic cylinder 25 retracts, then less traction will be applied to the middle axle tire 17. If too much traction is applied to the middle axle tire 17, this will cause the engine of the vehicle to load and decrease in efficiency as a result of the increasing engine output. Likewise, if insufficient traction is applied to the middle axle tire 17, this will cause the middle axle tire 17 to slip, and the vehicle 100 will not be able to maintain the desired speed because of this insufficient traction. Little traction pressure is actually needed to make the vehicle move especially over flat and level ground. The traction pressure needed to make the car move is less than the weight distributed to the wheels of the car. Consequently, if the weight was distributed to the middle axle tire 17, then the engine of the vehicle would have to work un-necessarily hard in order to move the car. For increased speed or traveling up an incline, additional traction pressure is required. In order to achieve this additional traction pressure, the hydraulic cylinder extends towards the road surface 26 in order to provide for increased traction pressure. FIG. 1 additionally illustrates a hydraulic pump 104 to pump air to the hydraulic cylinder 25 through the hydraulic hose 24. The hydraulic pump 104 which is located under the hood of the cab 10 is connected to a activation switch 108 which is positioned on the steering wheel 1 10 by electrical wires 106 and positioned in the vehicle 10 to be activated by the user of the vehicle 100. As discussed above, if there is insufficient traction pressure on the middle axle tire 17, the middle axle tire 17 will spin with respect to the other vehicle tires for example the front tire 13 or the rear axle tire 21. The speed of the middle axle tire 17 can be measured and compared by a first sensor shown in FIG. 3 as element 302. This difference in speed could be translated into an amount of increased or decreased traction and movement by the hydraulic cylinder 25 by microprocessor 306. Alternatively, the traction of the middle axle tire 17 could be measured directly by the second sensor 304to maintain traction between 25 to 20,000 lbs. The hydraulic cylinder 25 is attached to the frame 23 of the vehicle 100 and is connected to a hydraulic hose 24 which supplies hydraulic fluid to the hydraulic cylinder 25.

FIG. 1 additionally illustrates that the trailer 31 is connected to the vehicle by the trailer tow hitch 16 which is connected to the vehicle tow hitch 27. The trailer 31 includes trailer window 34 so that users of the trailer 31 can see out of the trailer 31. Additionally, trailer 31 includes trailer suspension 33 which is connected to the trailer tire 32 and which is connected to the frame of the trailer 31.

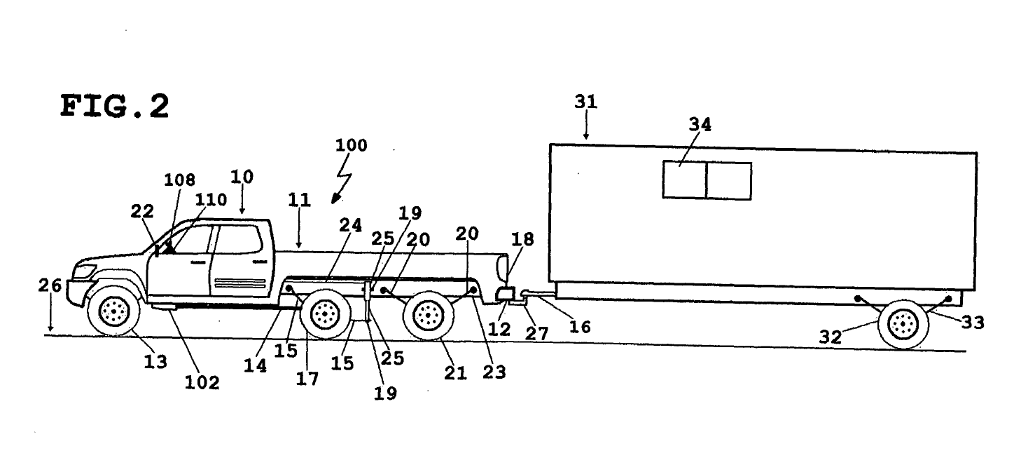

FIG. 2 illustrates that the hydraulic cylinder 25 in response to the microprocessor 306 has extended to the middle axle suspension 15 towards the roadway 26 to lower the middle axle tire 17 towards the roadway 26 and applies pressure (traction) to the middle axle tire 17 so that the proper traction is applied to the roadway 26.

FIG. 3 illustrates the vehicle 100 without the front tire 13, the middle axle tire 17 and the rear axle tire 21 in order to show the positions of the first sensor 302 and the second sensor 304. The first sensor 302 and the second sensor 304 are positioned near the front axle 30, the rear axle 28 and the middle axle 29.

The above description is not intended to be exhaustive or to limit the invention to the precise forms disclosed, and obviously many modifications and variations are possible in light of the above teachings. The embodiments were chosen and described in order to best explain the principles of the invention and its practical application to thereby enable others skilled in the art to best utilize the invention and various embodiments with various modifications as are suited to the particular use contemplated. It is understood that various omissions, substitutions of a equivalent are contemplated as circumstance may suggest or render expedient, but is intended to cover its the application or implementation without departing from the spirit or scope of the claims of the present invention.

1) A system for providing a variable traction to a drive wheel of a vehicle, comprising:
a front axle for supporting the weight of the vehicle;
a rear axle for supporting the weight of the vehicle;
a middle axle for providing said variable traction to said drive wheel of said vehicle.

2) A system for providing a variable traction to a drive wheel of a vehicle as in claim 1, wherein said middle axle is connected to a transmission.

3) A system for providing a variable traction to a drive wheel of a vehicle as in claim 2, wherein said middle axle is connected to said transmission by a middle axle shaft.

4) A system for providing a variable traction to a drive wheel of a vehicle as in claim 1, wherein said weight is distributed between said front axle and said rear axle.

5) A system for providing a variable traction to a drive wheel of a vehicle as in claim 1, wherein said traction is adjusted by a hydraulic cylinder.

6) A system for providing a variable traction to a drive wheel of a vehicle as in claim 5, wherein said hydraulic cylinder is connected to said vehicle with a bolt.

7) A system for providing a variable traction to a drive wheel of a vehicle as in claim 5, wherein said hydraulic cylinder extends by inflating.

8) A system for providing a variable traction to a drive wheel of a vehicle as in claim 5, wherein said hydraulic cylinder retracts by deflating.

9) A system for providing a variable traction to a drive wheel of a vehicle as in claim 5, wherein said hydraulic cylinder is attached to a hydraulic hose.

10) A system for providing a variable traction to a drive wheel of a vehicle as in claim 5, wherein said hydraulic cylinder is a connected to a hydraulic pump.

11) A system for providing a variable traction to a drive wheel of a vehicle as in claim 10, wherein said hydraulic pump is positioned within a hood of said vehicle.

12) A system for providing a variable traction to a drive wheel of a vehicle as in claim 11, wherein said hydraulic pump is connected to said hydraulic hose.

13) A system for providing a variable traction to a drive wheel of a vehicle as in claim 5, wherein said hydraulic cylinder is attached to an end of a middle axle suspension with bolts.

14) A system for providing a variable traction to a drive wheel of a vehicle as in claim 5, wherein said hydraulic pump is activated by an activation switch positioned within the cab.

15) A system for providing a variable traction to a drive wheel of a vehicle as in claim 14, wherein said hydraulic pump and said activation switch is connected with an electrical wire.

16) A system for providing a variable traction to a drive wheel of a vehicle as in claim 5, wherein said hydraulic cylinders lift and depress the middle axle.

17) A system for providing a variable traction to a drive wheel of a vehicle as in claim 1, wherein said traction is sensed by a sensor.

18) A system for providing a variable traction to a drive wheel of a vehicle as in claim 17, wherein said system includes a controller to receive inputs from said sensors and to vary the traction in accordance with said sense signals from said sensors.
